(19) United States
(12) Patent Application Publication
(10) Pub. No.: US 2015/0138532 A1
(43) Pub. Date: May 21, 2015

(54) MOTION STRATEGIES FOR SCANNING MICROSCOPE IMAGING

(71) Applicant: 3SCAN INC., San Francisco, CA (US)

(72) Inventors: Matthew GOODMAN, San Francisco, CA (US); Cody DANIEL, San Francisco, CA (US)

(21) Appl. No.: 14/529,503

(22) Filed: Oct. 31, 2014

Related U.S. Application Data
(60) Provisional application No. 61/897,913, filed on Oct. 31, 2013.

(51) Int. Cl. G02B 21/36; G01N 21/55; G02B 21/00; G01N 1/28

(52) U.S. Cl. CPC G02B 21/362; G01N 1/286; G01N 21/55; G02B 21/002; G01N 2001/2873; G01N 2201/06113; G01N 2201/02
USPC 356/36

(57) ABSTRACT

Motion strategies in two and three dimensions for scanning microscope imaging are described. An object, sample, or specimen is mounted on a precision three-dimensional stage. The object is moved concurrently with respect to a first axis and a second axis orthogonal to the first against a cutting tool to cut the object. An image of the cut portion is generated as the object is moved. The cutting tool may act as an optical waveguide for illuminating the portion of the object cut. An optical element captures images of the cut and illuminated object. The object may further be concurrently moved with respect to a third axis orthogonal to both the first and second.

### CROSS-REFERENCE

This application claims the benefit of U.S. Provisional Application No. 61/897,913, filed Oct. 31, 2013, which application is incorporated herein by reference.

### BACKGROUND OF THE INVENTION

The present disclosure generally relates to systems and methods for imaging an object. In particular, the present disclosure relates to the sectioning of biological tissue and other material samples using a microtome, and more particularly microtome slicing trajectories.

The field of microscopy has become increasingly important in today's society. One aspect of microscopy relates to the imaging of a specimen or object sought to be evaluated. Imaging generally refers to data collection in order to generate visualization of a given area. The ability to efficiently and accurately image data relating to a given specimen may be important for determining one or more characteristics associated with the specimen or object.

In many microscopy and imaging applications, a microtome is used to cut a thin slice of a specimen for imaging. The use of conventional microtomes has a rich 100+ year history. The earliest microtomes were no more than a hand drawn razor-blade and were documented in the late 1800s. More complicated versions were seen a bit later with devices that employed a hand-wheel which took slices when the crank was turned.

Microtomes have been refined since earlier times by employing advances in mechanical engineering, precision manufacturing, and blade materials to improve performance. The primary drivers of such advancement have been the improvements in optical microscopy and advent of electron microscopy which necessitated thinner slices with less optical artifacts. Despite the present advancements, the process of slicing samples has remained largely manual. Typically, a human hand-crank tied to underlying precision articulated machinery is used to operate the microtome. Less common are systems in which the specimen and the blade interact with a “rotary” motion.

Some conventional microtomes automate the slicing motion after sample setup is complete. For example, some systems may include a motorized version of the hand-cranked approach. More advanced conventional microtome may use a linear motor to drive the slicing motion.

Whether manually operated or motorized, many imaging systems that use microtomes may be less than ideal in at least some instances. Such systems may leave artifacts on the sample slice. One type of artifact that may occur is “chatter” or indentations parallel to the edge of the microtome or knife and perpendicular to the direction of cutting that are left on the sample slice often as a result of vibrations of the microtome or knife. Chatter is shown in FIG. 7A discussed below. Another type of artifact is “stripes” or features perpendicular to the edge of the microtome and parallel to the direction of cutting that are left on the sample slice often as a result of surface imperfections in the microtome. Stripes are shown in FIG. 7B discussed below. Yet another type of artifact is that the sample slice may curl as it is being cut instead of remaining flat as desired. Such curling of the sample may interfere with the imaging of the sample. FIG. 7C shows a sample 26 being cut by a knife edge 16 to generate a slice 76 which curls. These and other artifacts can result in the distortion of images, low resolution, poor efficacy, and slow speed. Accordingly, improved systems and methods for sectioning and imaging specimens and samples are desired.

### SUMMARY OF THE INVENTION

Improved systems and methods for the sectioning and imaging of biological tissue and other material samples using a microtome are disclosed. In particular, microtome slicing trajectories that minimize or reduce the occurrence of artifacts and enable fast and high resolution imaging, better slice capture, better microscopic examination, and/or better molecular interrogation are disclosed. Such slicing trajectories can be implemented on a sectioning microscopy system in which the microtome can act as an optical waveguide and the specimen is captured on a three-axis or three-dimensional stage which precisely moves the specimen in accordance with user-entered commands.

An aspect of the disclosure provides a method of imaging an object. The object may be moved with respect to a first axis against a cutting tool to cut a portion of the object. Concurrently, the object may be moved with respect a second axis against the cutting tool to cut the portion. The second axis is typically orthogonal to the first axis. An image of the cut portion may be generated as the object is moved with respect to both the first and second axes.

The object may further be moved with respect to a third axis against the cutting tool to cut the portion. This third axis is typically orthogonal to both the first axis and the second axis. And, the object may be moved with respect to the first axis, the second axis, and the third axis concurrently. The third axis may comprise a Z-axis which is orthogonal to a length of a cutting edge of the cutting tool and is orthogonal to a width of a body of the cutting tool.

Typically, the first axis comprises an X-axis which is orthogonal to the length of the cutting edge and is along the width of the body of the cutting tool. And, the second axis comprises a Y-axis which is along the length of the cutting edge and is orthogonal to the width of the cutting tool body or a Z-axis which is orthogonal to the length of the cutting edge and is orthogonal to the width of the body of the cutting tool.

The cutting tool is typically stationary relative to the moved object.

Furthermore, optical energy may be directed out of the cutting tool and through the portion of the object. And, the directed optical energy may be received at an optical element while the portion is cut such that data relating to an image associated with the portion is communicated to the optical element. The optical element may comprise a camera. The optical energy may be provided at a proximal end of the cutting tool. And, the cutting tool may internally reflect the provided optical energy from the proximal end to a distal end of the cutting tool. The internally reflected optical energy may be directed out of the distal end.

The object may be moved with respect to the two or more of the first, second, and third axes concurrently to implement a variety of different motion strategies or trajectories.

The object may be moved with respect to the first axis a first distance and moved along the second axis a second distance different from (e.g., less than) the first distance.

As the object is moved with respect to the first and second axes concurrently, the angle of the top surface of the object against the bottom surface of the cutting tool (e.g., the rake angle) may be changed.

The object may be oscillated with respect to the second axis as it is moved with respect to the first axis. Such oscillation may generate a cut portion having a varying thickness.

Movement of the object with respect to the first and second axes concurrently may generate a first steep cut in a first direction in the portion of the object, generate a second flat cut in the portion of the object, and generate a third steep cut in a second direction opposite the first direction in the portion of the object.

Further motion strategies or trajectories are described below.

Another aspect of the disclosure provides a system comprising a processor and tangible medium embodying instructions for implementing any of the above motion strategies or trajectories.

Other goals and advantages of the disclosure will be further appreciated and understood when considered in conjunction with the following description and accompanying drawings. While the following description may contain specific details describing particular embodiments of the disclosure, this should not be construed as limitations to the scope of the disclosure but rather as an exemplification of preferable embodiments. For each aspect of the disclosure, many variations are possible as suggested herein that are known to those of ordinary skill in the art. A variety of changes and modifications can be made within the scope of the disclosure without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1A is a schematic in side view illustrating an imaging system in accordance with many embodiments;

FIG. 1B is a flowchart illustrating a series of steps associated with the imaging system of FIG. 1A in accordance with many embodiments;

FIG. 2 is a perspective view of the imaging system of FIG. 1A showing additional details of the imaging of a specimen in accordance with many embodiments;

FIG. 3 is a sectional side view of the imaging system of FIG. 1A illustrating details associated with angles included therein in accordance with many embodiments;

FIG. 4 is a side view of an alternative embodiment of the imaging system of FIG. 1A;

FIG. 5 is a sectional side view of yet another alternative embodiment of the imaging system of FIG. 1A;

FIG. 6 is a block diagram illustrating a wavelength division multiplexing (WDM) process used in conjunction with the imaging system of FIG. 1A in accordance with many embodiments;

FIG. 7A is a perspective view of a specimen being cut to generate a section with chatter;

FIG. 7B is a perspective view of a specimen being cut to generate a section with stripes;

FIG. 7C is a perspective view of a specimen being cut to generate a section with curling;

FIG. 8A is a schematic diagram of a specimen being moved with respect to a single axis linearly to generate a section;

FIG. 8B is a schematic diagram of a specimen being moved with respect to two axes linearly to generate a section;

FIG. 9 is a schematic diagram of a specimen being moved with respect to two axes in a rotational manner to generate a section;

FIG. 10 is a schematic diagram of a specimen being moved with an oscillating manner to generate a section;

FIG. 11A is a schematic diagram of a specimen sequentially cut to generate sections; and

FIG. 11B is a schematic diagram of a specimen sequentially cut with an offset to generate sections.

### DETAILED DESCRIPTION OF THE INVENTION

Example embodiments of the present disclosure and their advantages are best understood by referring now to the drawings herein in which like numerals refer to like parts.

Embodiments described herein may provide a number of technical advantages. For example, back scattering effects, which relates to undesired data, may be substantially reduced or effectively eliminated. With the use of a cutting instrument that serves as an optical collimator, imaging of only a portion of the specimen to be examined can be achieved. Thus, inadvertent imaging of the area below the portion of the cutting instrument may be eliminated. This may allow the specimen to be evaluated in great detail with enhanced accuracy and efficacy and without back scattering from portions of the specimen below the cutting instrument.

Because imaging is performed as a section of the specimen is being cut by the cutting instrument, potential damage to or degradation of the specimen may be substantially avoided. By allowing a continuous and concurrent image scanning (i.e. while a layer of the specimen is being sectioned), wrinkling, deformation, or tearing of the specimen generally associated with removing the layer before imaging it is significantly reduced or avoided. Further technical advantages can be provided by using the multi-dimensional motion strategies and trajectories described herein.

As described herein, a conventional microtome may comprise a device in which a block of material is precisely cut such that a very thin layer of material is removed, or sectioned from the surface of the block. Similarly, conventional microtomy may apply to the functioning of the conventional microtomes. In these devices, the relative motion between the sample and cutting surface during the slicing motion is often confined to a single linear or rotational axis. While many designs exist, the most frequent arrangement is such that the block is fixed to one end of a vertically movable arm and is engaged with a stationary knife edge.

As described herein, a knife may comprise a parting surface designed to separate a thin layer from the face of a sample. A typical knife may be made of metal, glass, or diamond, but other exotic materials including tungsten carbide, sapphire, and other ceramics can be used as well.

As described herein, a section or slice may comprise a single strip of contiguous material that was removed from the block face by means of relative motion between the sample and the knife.

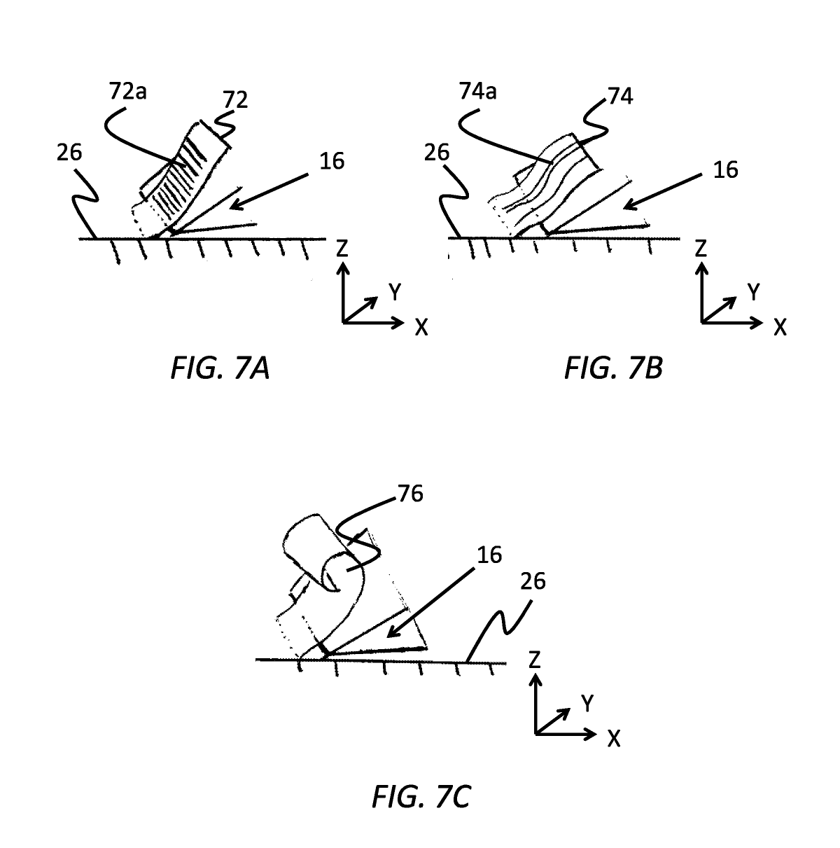

As described herein, chatter may refer to indentations left by a knife on the freshly cut block face and slice. The orientation of these features is generally parallel to the edge of the knife and perpendicular to the direction of cutting. The depth, and frequency, of these indentations can vary in scales from nanometers to microns. These patterns often exhibit a “Venetian-blind”-like periodic, parallel character in microscopic inspection. These marks are typically caused by vibrations in the knife edge relative to the sample caused by cutting forces. Chatter can make microscopic examination more difficult, and in extreme cases may damage or destroy slices. FIG. 7A shows a sample 26 being cut by a knife edge 16 to generate a slice 72 with chatter 72a.

As described herein, stripes may refer to indentations left by a knife on the freshly cut block face and slice. The orientation of these features is generally perpendicular to the edge of the knife and parallel to the direction of cutting. These indentations are typically caused by damaged or dull portions of the knife edge, but also possibly sectioned material inclusions being driven by the knife edge or faces. FIG. 7B shows a sample 26 being cut by a knife edge 16 to generate a slice 74 with stripes 74a.

The axis orientations described herein here are typically referenced with respect to standard Cartesian “xyz” right-handed coordinate system, with three linear, orthonoromal axes. The “x-axis” may be taken as the primary axis along which the sample is sliced in a conventional microtome. The “y-axis” is often not present in most conventional microtomes, as such the maximum width of a sectioned sample may be limited in size to the width of the blade. The “z-axis” may be taken as facing out from the sample block face and is the axis in a conventional microtome associated with the thickness of successive serial slices taken from the face.

As described herein, a block face will generally refer to the face of a sample that is being sliced. In a conventional microtome, the block face is typically in plane with the xy-axes. The block face in a conventional microtome is typically less than the width of the knife.

As described herein, the rake angle is generally the angle at which a slice will move up the knife face as measured perpendicular to the block face.

As described herein, the clearance angle is generally the solid angle between the back side of the knife and the sample as it is being cut.

FIG. 1A shows an imaging system 10 in accordance with many embodiments. Imaging system 10 may be used to implement one or more of the microtome motion strategies or trajectories described herein. Imaging system 10 may include an optical element 12, a line generator 14, and a cutting instrument 16. A base 18 may be provided to stabilize imaging system 10. Additionally, an X-axis stage 20, a Y-axis stage 22, and a Z-axis elevator stage 24 may also be provided in order to position or otherwise effect movement of a specimen 26 to be examined or otherwise evaluated using imaging system 10. (Specimen 26 has a thickness that been exaggerated in FIGS. 1A through 6, as compared to one example thickness, in order to facilitate a greater understanding of the embodiments disclosed herein; this exaggeration should not be construed to limit or otherwise restrict the present disclosure in any way and has been offered only for teaching purposes. The present disclosure may be utilized with specimens having any thickness.)

According to many embodiments, the microtome or cutting instrument 16 may serve as an optical waveguide or prism for imaging system 10 and may also serve to physically section a portion of specimen 26. Physical sectioning of specimen 26 may be performed concurrently with imaging, or data acquisition, of the portion being cut; optical element 12 and line generator 14 may cooperate with each other and with the cutting instrument 16 in order to facilitate this process. This can allow three dimensional volume imaging to be accomplished simultaneous with the sectioning of specimen 26. According to many embodiments, the integrity of specimen 26 may also be maintained during the sectioning process as a result of specimen 26 being sampled in situ at a high rate of speed while avoiding the problems of: 1) over-exposure to optical energy provided by line generator 14, and 2) degradation or deformation of a portion of specimen 26 that may be physically removed and repositioned before imaging the desired area. Additionally, the imaging system 10 may ensure that an accurate image of a target area of specimen 26 can be captured because of the inherent nature of cutting instrument 16 operating as an optical prism. Cutting instrument 16 may provide a barrier to interference data that would otherwise be collected from layers of specimen 26 below the portion being sectioned by cutting instrument 16. This unwanted interference data, or backscattering, may operate to reduce the accuracy of an associated system, whereas the present imaging system 10 can substantially avoid this dilemma.

Optical element 12 may serve to receive or otherwise collect optical energy reflected at cutting instrument 16. According to many embodiments, optical element 12 may comprise a microscope, a slit-scan camera, a set of linear array sensors, and one or more lenses. Additionally, optical element 12 may be inclusive of only a camera or only a microscope or any combination thereof. Alternatively or in combination, optical element 12 may be any component, unit or structure operable to receive or otherwise collect optical energy reflected by cutting instrument 16.

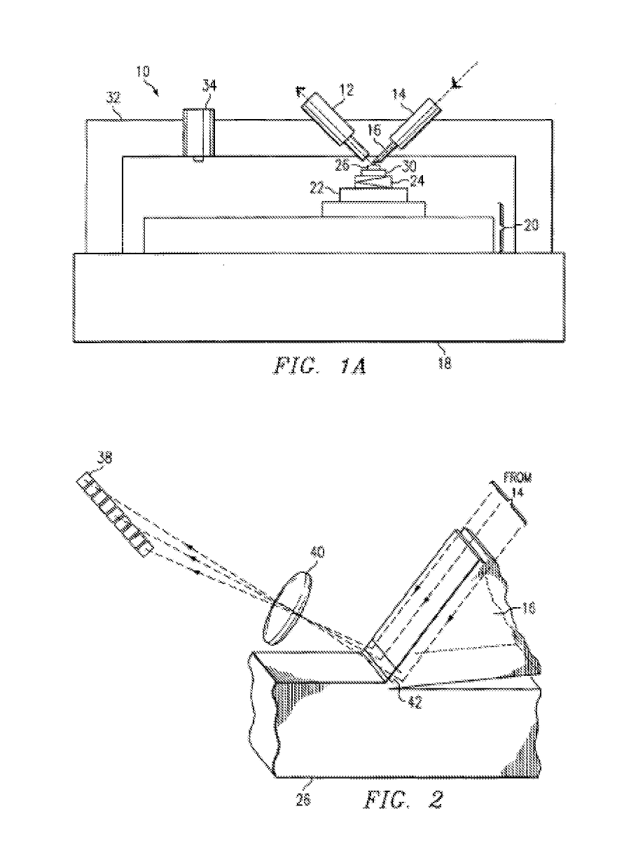

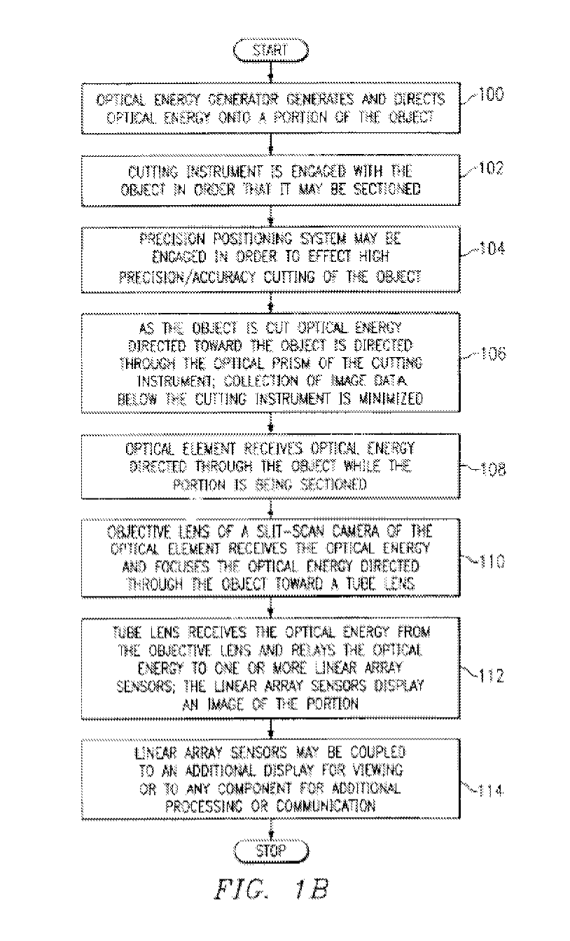

According to many embodiments, the microscope, the slit-scan camera, the set of linear array sensors, and the lenses of optical element 12 may cooperate in order to image a target area being sectioned by cutting instrument 16. Unlike a conventional digital camera that provides an area scan of a target, a slit-scan camera included in optical element 12 may generally capture a narrow target area, directing the data in one direction to one or more linear array sensors. Although optical element 12 is described as including a slit-scan camera, any other suitable camera operable to image a section of specimen 26 in cooperation with one or more linear array sensors may be used. Additional details relating to the lenses and the linear array sensors included within the internal structure of optical element 12 are described below with reference to FIG. 2.

Line generator 14 may be an optical energy generator operable to generate a laser beam according to many embodiments. Line generator 14 may generate a laser beam approximately 30 microns wide and the length of the edge of cutting instrument 16 that is directed toward the portion of specimen 26 to be sectioned in some embodiments; however, line generator 14 may in the alternative generate any other suitable optical energy beam. Line generator 14 may be positioned at an angle of approximately 45° to specimen 26 in some embodiments; however, line generator may be positioned at any other suitable angle according to particular needs. Line generator 14 may be positioned such that optical element 12 may effectively gather or otherwise capture optical energy transmitted, reflected, or otherwise communicated by the portion of specimen 26 being sectioned. In some embodiments, line generator 14 may be a white light source generator providing an optical beam of white light to specimen 26 to be reflected and imaged by optical element 12. The white light source generator may generally provide a sufficiently narrow optical image line beam to specimen 26 for processing suitable to and coordinated with optical element 12. Although described as an optical energy generator operable to generate a laser beam, line generator 14 may be any suitable optical source or component that can generate, supply, or otherwise direct optical energy toward specimen 26. Line generator 14 may be positioned such that it is co-axial with cutting instrument 16. When line-generator 14 is co-axial with cutting instrument 16, optical energy may be generated and directed proximate to or through cutting instrument 16 and onto specimen 26.

One concern associated with volume imaging addressed by many embodiments is the degradation or deformation aspects of light generally on a given specimen. Essentially, if the specimen fails to move quickly enough, specimen 26 may be damaged (potentially irreparably). Thus, imaging system 10 may provide the advantage of maintaining a suitable speed or an appropriate course of motion without overexposing tissue associated with specimen 26 to the potentially damaging effects of light. In some embodiments, imaging system 10 accomplishes this desired movement while maintaining high levels of precision, accuracy, and resolution in the image acquisition.

Cutting instrument 16 may comprise a knife that includes a tip acting as an optical prism for reducing the visibility of tissue below the edge of the tip. Thus, cutting instrument 16 can be used as an optical collimator for the optical train for optical element 12. The tip of cutting instrument 16 internally-reflects optical energy directly toward optical element 12 such that excitation energy generally propagating in improper directions and negatively influencing imaging accuracy may be substantially reduced or otherwise eliminated. According to many embodiments, cutting instrument 16 has a tip formed of diamond that operates to section a portion of specimen 26 to be examined. The diamond tip will typically be transparent and can effectively act as an optical prism as described above. Use of an optical prism in cutting instrument 16 also may avoid unwanted fluorescence bleaching from deep voxels associated with conventional image scanning devices in certain applications. This fluorescent bleaching may operate to generally hinder the accuracy or skew the results of an associated imaging data or scanning system.

The tip of cutting instrument 16 may be sharpened such that its edge is approximately 1-5 nanometers in some embodiments; however, the tip may be any other suitable sharpness according to particular needs. Generally, the top surface of the cutting instrument 16 is oriented at a 45° degree angle to the top surface of the specimen 26. Although described as having a diamond tip, cutting instrument 16 may include any edge operable to facilitate sectioning or bifurcation of specimen 26. Additionally, cutting instrument 16 may include a tip formed of any other suitable material for sectioning specimen 26, such as glass, metal, crystal, sapphire, and plastic, for example. In some embodiments, a microtome or a laser may be used to facilitate the sectioning of specimen 26 to be examined using imaging system 10.

Base 18 may comprise a flat ground granite platform according to many embodiments. Base 18 may provide stability for specimen 26 so that it may be sectioned accurately. Base 18 may support X-axis stage 20, Y-axis stage 22 and so Z-axis elevator stage 24. Although described as a high resolution precision platform, base 18 may alternatively or in combination comprise a mechanical structure, such as a ball and screw stage, for example, or any other suitable structure operable to provide stability and/or maneuverability to specimen 26. Additionally, although described as being formed of granite, base 18 may be formed of any suitable material or be eliminated entirely according to particular needs. Base 18 may support X-axis stage 20, which may be positioned on top of a flat surface of base 18.

X-axis stage 20 may support specimen 26 in order that it may be sectioned and imaged. X-axis stage 20 may provide movement in one direction according to many embodiments. X-axis stage 20 may comprise an air-bearings stage providing lateral movement and facilitating a cutting axis for cutting instrument 16 to section specimen 26. X-axis stage 20 may be a precision positioning stage providing resolution in the order of approximately 20 nanometers. This precision positioning system can ensure high accuracy synchronized imaging of the edge of cutting instrument 16 with movement of specimen 26. X-axis stage 20 may rest on base 18 and supports Y-axis stage 22.

Y-axis stage 22 may also be a precision stage providing movement in one direction, potentially perpendicular to the movement provided by X-axis stage 20. Y-axis stage 22 may provide high resolution indexing for specimen 26 to be examined or sectioned using cutting instrument 16. Y-axis stage 22 may also serve as a cutting axis, providing resolution in the order of approximately 20 nanometers according to many embodiments. Y-axis stage 22 supports Z-axis elevator stage 24.

Z-axis elevator stage 24 may provide movement in one direction (potentially vertical with respect to base 18) to specimen 26. Z-axis elevator stage 24 may provide resolution in the order of approximately 25 nanometers. Optionally, a mounting chuck 30 may be supported by Z-axis elevator stage 24; mounting chuck 30 in turn supports specimen 26. According to many embodiments, Z-axis elevator stage 24, Y-axis stage 22, and X-axis stage 20 may be all digitally controlled in order to effect precise indexing of specimen 26 or cutting instrument 16. Alternatively or in combination, each of these stages may be automatically manually controlled or remain substantially stationary according to particular needs. Because sampling of specimen 26 may be potentially completed tens of thousands of times over a short distance of sectioning of specimen 26, each of the stages may operate to facilitate collaborative high precision movement effecting accurate motion within imaging system 10. According to some embodiments, encoder resolutions for each of the stages may be in order of approximately 10 to 30 nanometers.

According to many embodiments, cutting instrument 16 may be rigidly mounted over Z-axis elevator stage 24 such that specimen 26 may be repeatedly sectioned into multiple sections. Under digital control, the three-axis precision stage system, as described above, may cooperate with cutting instrument 16 to function as a microtome, sectioning layers from specimen 26 approximately 0.5 microns thick, for example. Although described as a three-axis precision stage, it is contemplated that any blocks or elements used to support specimen 26 may be used in conjunction with imaging system 10. Additionally, the order of the X, Y, and Z stages 20, 22, and 24, respectively, may be varied or modified according to particular needs. It is also contemplated that any other type of support, mechanical or electronically controlled, may be used in order to effect accurate sectioning of specimen 26 or any other article or object sought to be evaluated. Also, while the X-axis stage 20, Y-axis stage 22, and Z-axis stage 24 are shown in FIG. 1A as distinct with inhomogenous motion controls, two or more of the X-axis stage 20, the Y-axis stage 22, or Z-axis stage 24 may comprise a single unit with homogenous motion controls as shown in FIG. 1C.

The three-axis precision stage comprising the X-axis stage 20, the Y-axis stage 22, and the Z-axis elevator stage 24 may comprise one or more motion stages available from Aerotech, Inc. of Pittsburgh, Pa. such as model nos. ANT95-25-XY, ANT95-25-XY-PLUS, ANT95-50-XY, ANT95-50-XY-PLUS, ANT95-25-XY-ULTRA, ANT95-50-XY-ULTRA, ANT130-060-XY, ANT130-060-XY-PLUS, ANT130-110-XY, ANT130-110-XY-PLUS, ANT130-160-XY, ANT130-160-XY-PLUS, ANT130-060-XY-ULTRA, ANT130-110-XY-ULTRA, ANT130-160-XY-ULTRA, PlanarDL-100XY, PlanarDL-200XY, PlanarDL-300XY, ABL36025, ALS36210, ALS36220, ALS36230, ALS36240, ATS36210, ATS36220, ATS36230, ATS36240, ABL90300-300, ABL90500-500, ABLH90750-750, ABLH91000-1000, ABLH91200-1200, AHL90350-350, Planar HD, MPS5OSV, MPS75SV, AVS/AVSI106, AVS/AVSI113, AVS/AVSI125, ANT95-3-V, ANT95-3-V-PLUS, ANT-130-5-V, ANT-130-5-V-PLUS, ANT130-035-L-Z, ANT130-035-L-Z-PLUS, ANT130-060-L-Z, ANT130-060-L-Z-PLUS, AVL1000-1, AVL1000-2, AVS1005, AVS1010, WaferMaxZ, AirLift 115-050, AirLift 115-100, AirLift 115-150, ANT95-25-L-Z, ANT95-25-L-Z-PLUS, ANT95-50-L-Z, ANT95-50-L-Z-PLUS, ABL15005Z, ABL15010Z, ABL15015Z, ABL15020Z, MPS5OSV, MPS75SV, VTS300-050, VTS300-100, VTS300-150, VTS300-200, WaferMaxZ, and any combination thereof. The X-axis stage 20, the Y-axis stage 22, and the Z-axis elevator stage 24 will typically comprise linear motors which allow for precise and fast control with very low hysteresis in movement, high resolution (e.g., 1-2 nm), high repeatability (e.g., 25-100 nm), and high accuracy (e.g., 250-400 nm).

One or more of the X-stage 20, the Y-stage 22, or the Z-stage 24 may be moved separately, sequentially, or simultaneously with one another, for example, to achieve one or more of various motion patterns described herein. While the use of linear stages is described, it is also contemplated that one or more rotational stages may be used alone or in combination to hold and move the specimen 26, for example, to achieve one or more of various motion patterns described herein.

Specimen 26 may be biological tissue in many embodiments, such as biological tissue, for example; however, any other suitable element, item, or object may be used according to particular needs. The tissue may be sectioned into thin sections by cutting instrument 16 while being concurrently imaged by imaging system 10. Biological tissue may be any organic material such as bone, brain, heart, skin, muscle, or any other biological (plant, animal, etc.) material to which sectioning is sought. Alternatively, specimen 26 could be a non-biological material such as fiber-embedded polymers, carbon-embedded plastics, copper, microelectronic devices (potentially beneficial in the field of reverse engineering), or any other element or object sought to be sectioned, probed, or otherwise examined using imaging system 10. It is also contemplated that imaging system 10 may be portable and further operable to communicate with various types of devices and components that facilitate the imaging of or otherwise interface with imaging system 10.

Imaging system 10 may be potentially beneficial in florescence applications, where for example bleaching concerns are problematic. Imaging system 10 may be used to detect green fluorescent proteins in biological matter that serve to identify a host of parameters indicating one or more characteristics associated with a specimen having such proteins. The detection of the presence of such green fluorescent proteins may also signify a certain condition of the associated specimen. The imaging system 10 may also be used in any other inspection, assessment, or evaluation, whether on a microanatomical level or on a large scale basis (such as sectioning of a whole brain, for example). The imaging system 10 may be essentially applicable to any three dimensional/volume imaging of a given object, element, or specimen 26. Additionally, it is contemplated that phase/modulation microscopy, line-scanning microscopy, absorption techniques for imaging optical energy, or any other optical imaging system operable to gather or otherwise capture data relating to an image from an object that may be used in conjunction with and benefit from the teachings associated with imaging system 10.

A sectioning mill 34 is also illustrated in FIG. 1A and may be optionally provided on a bridge 32 in order to facilitate the sectioning of specimen 26. Sectioning mill 34 may operate to cut or otherwise separate an object, such as specimen 26 into two or more parts, to be evaluated using imaging system 10. Bridge 32 supports (via suspension, for example) sectioning mill 34 and may provide a sliding capability to sectioning mill 34 such that it may be positioned out of the way when sectioning of specimen 26 is not occurring. Bridge 32 may be coupled to base 18 positioned such that it provides minimal interference to imaging system 10.

FIG. 1B shows a flowchart illustrating a series of steps associated with imaging system 10 in accordance with many embodiments. At a first step 100, optical energy may be generated by line generator 14. In some embodiments, line generator 14 generates a laser beam having an approximate width of 20 to 40 microns that is directed toward the portion of specimen 26 to be cut; however, any other suitable optical beam could be generated that propagates toward specimen 26. Cutting instrument 16 may be engaged with specimen 26 in step 102, such that specimen 26 may be sectioned or otherwise cut while optical energy is propagating toward specimen 26.

At step 104, a precision positioning system, such as the one described above with reference to FIG. 1A, may be implemented in order to effect accurate sectioning of specimen 26. The precision positioning system may be electronically or digitally controlled and may operate to section specimen 26 into very thin sections, in the order of 0.1 to 10 microns in some embodiments; however, any other suitable sectioning may be accomplished with use of the precision positioning systems described herein.

At step 106, optical energy may be reflected from the optical prism of cutting instrument 16 toward optical element 12. Use of cutting instrument 16 with the accompanying optical prism may ensure that backscattering, i.e. the collection of unwanted data associated with the part of specimen 26 just below the portion being sectioned, may be reduced or otherwise avoided. Optical element 12 may receive the reflected optical energy at step 108 while specimen 26 may be being sectioned by cutting instrument 16.

According to many embodiments, lenses 40 of the slit-scan camera within optical element 12 receive the optical energy reflected by the prism and relating to the portion of specimen 26 being cut at step 110. The objective lens may operate to focus the reflected optical energy onto the relay lens; the relay lens communicates the reflected optical energy to one or more linear array sensors 38 as described in step 112. Once the reflected optical energy is at linear array sensors 38, it may be further processed in a number of ways.

According to the many embodiments, a display is provided at step 114. The display may receive and utilizes the captured images held by one or more linear array sensors 38 to provide a cohesive illustration of the portion of specimen 26 being cut and examined. Alternatively or in combination, one or more of the linear array sensors 38 may be coupled to a processor or any other suitable component for additional processing, modification or communication to a next destination.

In operation, optical energy may propagate from line generator 14 toward specimen 26 positioned optionally on mounting chuck 30. The optical energy may be reflected at a surface of cutting instrument 16 as cutting instrument 16 operates to section a portion of specimen 26 to be analyzed. For purposes of example, specimen 26 may comprise a mouse brain to which volume data acquisition is sought. The mouse brain may be embedded in a plastic block in preparation for a systematic removable of multiple sections of a portion of specimen 26. The slit-scan camera provided in optical element 12 may include a 40× objective having an associated field of view (cutting instrument 16 tip width) of 0.625 millimeters.

In operation, multiple strips of the example mouse brain (approximately 0.625 millimeters wide by 13 millimeters long in one example) may be cut for each Z-axis elevator stage 24 elevation, in a quasi “field-plowing” scenario, i.e. following a serpentine pattern. For a plastic block height of 6 millimeters, approximately 12,000 sections of specimen 26 may be cut, each approximately 0.5 microns thick; however, these sections may alternatively be cut in any other suitable fashion according to particular needs. The precision positioning systems, as described above, may be used to facilitate highly accurate sectioning of the mouse brain to be examined.

Once the optical energy is reflected at the layer of mouse brain being sectioned, optical element 12 in operation may capture the reflected energy by a set of optical lenses, which then image the portion being sectioned onto one or more linear array sensors 38 (FIG. 2). Linear array sensors 38 may project or otherwise display the image of the portion at the edge of cutting instrument 16 or alternatively communicate the information for further processing or for display at a remote location. Linear array sensors 38 are described below in greater detail with reference to FIG. 2.

FIG. 2 illustrates additional details of imaging system 10 including one or more linear array sensors 38 and a set of lenses 40. Linear array sensors 38 and lenses 40 may be included within optical element 12 in order to facilitate imaging of specimen 26. Alternatively or in combination, these components may be exterior to optical element 12 where appropriate and according to particular needs.

According to many embodiments, linear array sensor 38 may receive optical energy reflected by a portion of specimen 26 to be imaged. Generally, a particular section of specimen 26 being imaged onto one or more linear array sensors 38 as the section may be cut by cutting instrument 16. The particular section of specimen 26 to be imaged is illustrated as a band 42.

A single line of tissue from specimen 26 may be imaged onto a single array within linear array sensor 38. Linear array sensors 38 may operate to detect a series of lines being illuminated by line generator 14 at the tip of cutting instrument 16. It is contemplated that the slit-scan camera may be included within optical element 12 (either by itself or with accompanying additional components such as lenses 40) and may image multiple lines of data associated with specimen 26, onto multiple (potentially parallel) linear array sensors 38. As the tissue of specimen 26 is moved, or as cutting instrument 16 sections part of specimen 26, the image data may be moved in synchronization to a register coupled to linear array sensors 38, where it may be further processed, stored or displayed. This process can allow greater visibility of the same line of a portion of specimen 26 being cut, potentially imaging the target area a hundred times before proceeding to a subsequent line or area of specimen 26 to be imaged.

Band 42 can be brought into focus by lenses 40 of an accompanying microscope (potentially along linear array sensors 38 within optical element 12). According to the many embodiments, the slit-scan camera within optical element 12 samples an area of specimen 26 at a rate of approximately 44,000 times per second, i.e. a new line being sampled repeatedly and in a constant progression in one embodiment; however, any other suitable sampling protocol may be used where appropriate. After indexing by motion of any one of the axis stages (Y or Z), the X-axis sampling may be synchronized with the motion of X-axis stage 20, as described above with reference to FIG. 1A or alternatively may be synchronized with the motion of cutting instrument 16 or more directly with specimen 26.

Lenses 40 may include an objective lens and a tube lens according to many embodiments. The objective lens may operate to focus an image of specimen 26 at band 42 onto linear array sensor 38. It is contemplates that dry objective lenses may be used for applications such as cutting in air; alternatively or in combination, it is contemplated that sectioning of specimen 26 may be under oil, water, involve frozen specimens, pressurized specimens, or any other appropriate element or object existing in any other suitable environment in which three dimensional imaging is sought. The objective lens may communicate imaged parallel rays reflected by a portion of specimen 26 represented at band 42 onto the tube lens. The tube lens may operate as a relay and communicates parallel rays back into an image to be received by linear array sensor 38. This optical matching process between lenses 40 may be associated with infinity optics according to many embodiment.

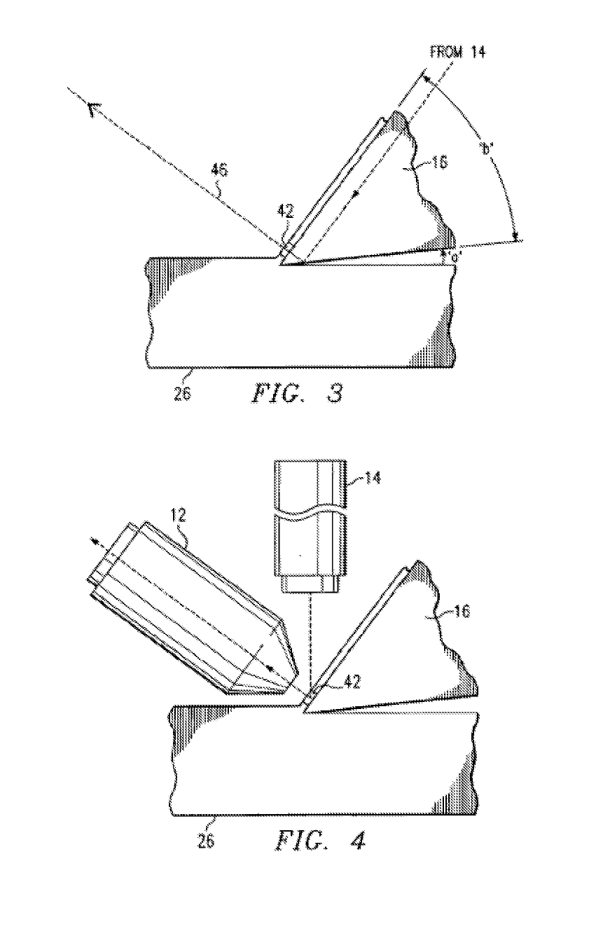

FIG. 3 is a diagrammatic side view illustrating additional details relating to the positioning of cutting instrument 16. Angle “a” represents a clearance angle for the tip of cutting instrument 16. Angle “a” may be approximately 2° to 10° with respect to a horizontal line parallel to the surface of specimen 26; however, any other appropriate clearance angle may be used where appropriate. Additionally, an included angle “b” is provided that represents the placement of cutting instrument 16 in order to effect the sectioning of specimen 26. Angle “b” may be approximately 30° to 50° according to many embodiments; however, any other appropriate placement angle may be used according to particular needs. According to many embodiments, these angles operate to section a thin layer from specimen 26. As described above, these disclosed angles ‘a’ and ‘b,’ are offered only for purposes of example; both angles may be varied significantly according to particular needs.

FIG. 3 also illustrates a dashed line 46, which represents the optical axis for optical system 12. Dashed line 46 may be directed at band 42 as knife 16 operates to cut a layer of tissue from specimen 26. According to the many embodiments, the layer of specimen 26 being cut is approximately 0.1 to 10 micrometers in thickness, this layer being simultaneously imaged as it is sectioned.

FIG. 4 shows the imaging system 10 including the line generator 14 as being positioned normal to a surface of specimen 26 before it is cut. Line generator 14 may operate to generate optical energy directed toward band 42 that is being imaged by optical system 12. Optical energy may be reflected at band 42 and received or otherwise captured by optical element 12 in order to affect imaging of a target layer of specimen 26. The imaging system 10 shown in FIG. 4 may operate in precisely the same manner as the imaging system 10 of FIG. 1A, with the exception of the varied placement of line generator 14.

FIG. 5 shows the imaging system 10 which has been slightly modified to include a prism 50 that may be positioned between line generator 14 and optical element 12. According to many embodiments, the prism 50 may be operable to serve as a one-directional transparent mirror allowing optical energy from one direction to be reflected at reflecting surface 52, while optical energy coming from a different direction passes directly through prism 50. Prism 50 may include a reflecting surface 52 that may operate to reflect optical energy generated by line generator 14 that propagates toward reflecting surface 52. The optical energy may be reflected at reflecting surface 52 and communicated toward band 42 of specimen 26, via optical element 12. Optical energy may be reflected at band 42 and communicated back to optical element 12 where the optical energy is then communicated to prism 50. At prism 50, the optical energy passes through reflecting element 52 and on to a display for potential processing or further review. The imaging system 10 illustrated in FIG. 5 in operation functions generally the same as imaging system 10 of FIG. 1A with the exception of the addition of prism 50 and the changed position of line generator 14.

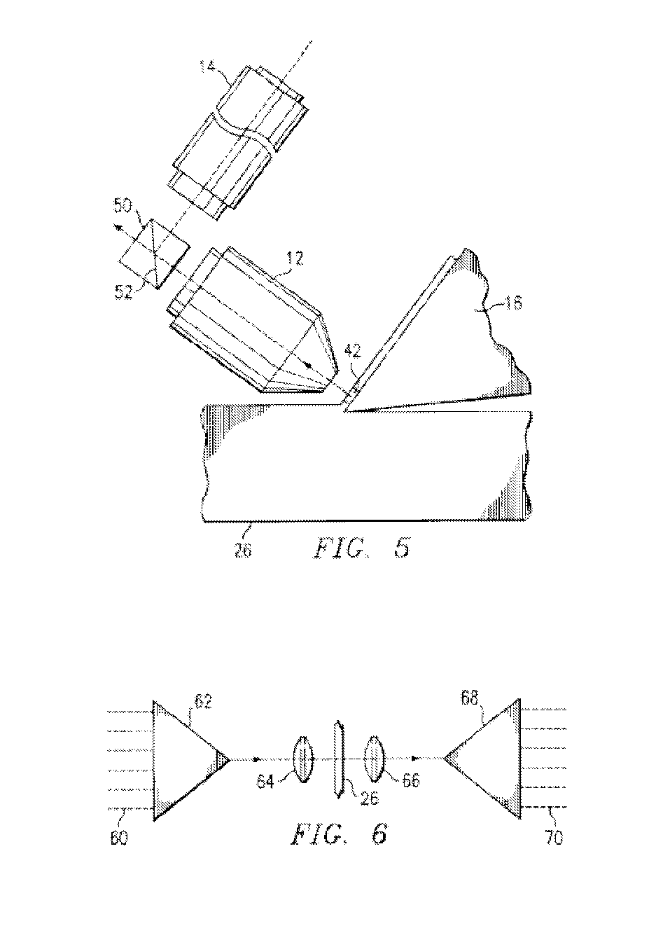

FIG. 6 is a block diagram illustrating a processing component of imaging system 10 according to many embodiments. FIG. 6 illustrates the use of several lasers, for example three laser beams, which serve as multiple optical sources, producing multiple colors within the spectrum. According to many embodiments, multiple laser line generators are used to generate optical energy. The use of multiple lasers allows imaging of specimen 26 with imaging system 10 using wavelength division multiplexing (WDM). In the case of several laser beams imaging a portion of specimen 26, each of the laser beams may have an associated wavelength (not necessarily consistent with each other). A variant of this scheme time-modulates the laser line generators in synchronization with gating linear sensor arrays 38, whereby multiple channels representing each laser are cycled.

A series of channels 60 representing multiple wavelengths is illustrated in FIG. 6 as being fed into a multiplexer 62. A collimating optical system 64 may be represented as receiving laser energy from multiple channels 60 via multiplexer 62. Collimating optical system 64 may represent line generator 14 as described above with reference to FIG. 1A. The optical energy received by collimating optical system 64 can then directed toward a portion of specimen 26 to be examined.

Specimen 26 reflects a portion of the optical energy it receives to an optical train system 66. Optical train system 66 may be inclusive of components such as the slit-scan camera, lenses 40, and linear array sensors 38 as described above with reference to FIG. 1A. Optical train system 66 includes a portion of the optical energy generated by the multiple laser beams. The optical energy may be communicated from optical train 66 to a demultiplexer 68. After the optical energy is demultiplexed, it may be communicated to a series of linear array sensors 70, similar to linear array sensors 38. Thus, according to many embodiments, wavelength defined channels are sent to physically separate linear array sensors 70. Single sensor arrays may be used within linear array sensors 70 such that channel colors are sorted or otherwise filtered during data acquisition relating to a portion of specimen 26 to be imaged. Thus, it should be recognized that the embodiment illustrated in FIG. 6 suggests an alternative manner of processing image data with the use of several optical energy sources or generators that involve a wavelength division multiplexing (WDM) approach to be used in conjunction with many embodiments. Although several embodiments have been illustrated and described in detail, it will be understood that various substitutions and alterations can be made therein without department from the present disclosure. For example, although imaging system 10 is described as being applicable to biological sectioning, the present disclosure provides applications in areas such as histology, clinical histopathology, industrial applications such as in textiles and plastics, and to any other surface or layer in which characteristics, properties, conditions or parameters are sought to be discovered. Such image scanning may also be particularly beneficial in biological research, more specifically gene expression research. Additionally, applications that involve the staining of cells may enjoy substantial success with use of the systems and methods of the present disclosure.

In addition, although described with reference to the placement of components at certain angles or in certain positions, it is contemplated that any suitable arrangement or placement of optical element 12, line generator 14, and cutting instrument 16 may be made without departing from the scope of the present disclosure. Also contemplated is the use of multiple line generators 14, multiple edged cutting instruments 16 (cutting multiple layers concurrently), and multiple optical elements 12 without departing from the teachings of the present disclosure. Additionally, the use of wavelength division multiplexing (WDM), or any other processing or communications techniques that may potentially use several optical energy generators are also contemplated.

The precision x-axis stage 20, y-axis stage 22, and z-axis stage 24 may be used in combination to move the mounted specimen 26 concurrently with imaging of the sectioned specimen 26. While any movement may be relative movement between the microtome 16 and the specimen 26, the microtome 16 will typically be stationary relative to the moving mounted specimen 26. The precise, coordinated motion of these three-dimensional stages can enable a number of slicing techniques impossible with known imaging systems. Other relative movement in two or more dimensions such as a combination of moving both the microtome 16 and the mounted specimen 26 or moving the microtome 16 while keeping the mounted specimen 26 stationary are also contemplated.

Linear Motion Strategies.

The specimen 26 may be moved linearly or translated in many ways. The speed by which the specimen 26 is moved may be constant or varied (e.g., increasing speed, decreasing speed, or both) for many reasons.

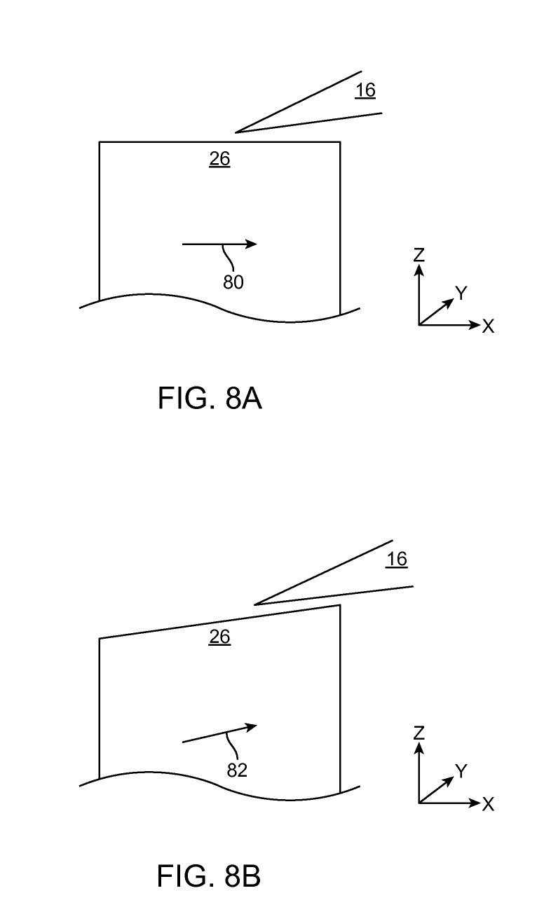

One, the specimen 26 may be moved in a single axis to generate linear slices. These slices are analogous to the slices taken by a convectional microtome. FIG. 8A shows an example of the specimen 26 moved in a single axis (toward the right as shown by arrow 80) against the stationary microtome 16 to section the specimen 26.

Two, the specimen 26 may be moved in a single axis and with variable speed along the length of the linear slice. These slices may mimic the recorded stroke of an experienced histologist. Alternatively or in combination, the variation in speed along the linear slice may be adapted to the material properties of the specimen along the cutting path. FIG. 8A shows an example of the specimen 26 moved in a single axis (toward the right as shown by arrow 80) against the stationary microtome 16 to section the specimen 26.

Three, the specimen 26 may be moved linearly in two axes, and in particular the x and z axes. Coordinated motion in this x-z plane may offer a significant advantage over a conventional microtome in that the relative rake and clearance angle of the cut is a function of the coordinated motion of the two axes. This may minimize or eliminate the need for a knife holder with an adjustable rake angle as relative motion between the knife and block create set the rake and clearance angle of the slice. FIG. 8B shows a schematic of this motion with the specimen 26 moved in two axes (upward and toward the right as shown by arrow 82) against the stationary microtome 16 to section the specimen 26. As shown in FIG. 8B, the mounted specimen 26 is moved in the two axes with a constant rate to provide a uniform cutting angle. The mounted specimen 26 may be moved at a constant speed or a variable speed along the cut for the purpose(s) described above for example.

Four, the specimen 26 may be moved linearly in two axes, and in particular the x and y axes. Coordinated motion in this x-y plane may offer a significant advantage over a conventional microtome in that in plane angular misalignment of the blade cartridge can be corrected simply. Similarly, this approach may eliminate the need for blade “yaw” correction in the knife holder. In some embodiments, the microtome 16 may be significantly longer than the specimen 26 in the y-direction and the microtome 16 may have one or more imperfections along the y-direction. And, the specimen 26 may be moved so the portion of the microtome 16 with the least imperfection is used to section the specimen 26 to reduce the occurrence of artifacts. The mounted specimen 26 may be moved at a constant speed or a variable speed along the cut for the purpose(s) described above for example.

Five, the specimen 26 may be moved linearly in a coordinated manner in all three axes—x, y, and z. This approach is functionally a fusion of the two above approaches. It has both of their advantages and can allow for a radically simple knife holder design with no adjustable components, and assumes only loose tolerances on the blade cartridge assembly. The mounted specimen 26 may be moved at a constant speed or a variable speed along the cut for the purpose(s) described above for example.

Cylindrical/Rotational Motion Strategies.

The specimen 26 may be moved in a rotational or cylindrical manner or rotated in many ways. Two exemplary cylindrical motion strategies are described below. In discussing these slicing strategies, the plane on which the circular curve proceeds is denoted without discussion of the motions of the remaining axis. These motions can be combined with other motion types. The speed by which the specimen 26 is moved may be constant or varied (e.g., increasing speed, decreasing speed, or both) for many reasons.

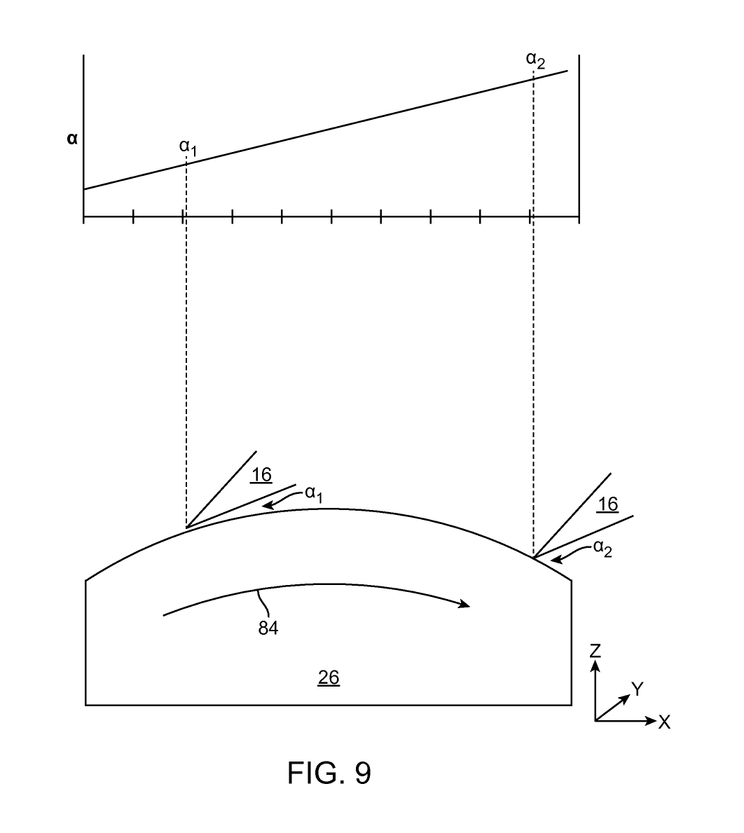

In a first motion strategy, the specimen 26 may be moved cylindrically in the x-z axes as shown in FIG. 9. This slice motion may allow the simultaneous exploration of a number of rake angle settings with a single slice. As seen in FIG. 9, during a cylindrical slice, the knife 16 will pass through a number of different rake angles α (including, for example, angles α₁ and α₂) in a continuous path as the specimen 26 moves cylindrically in the direction indicated by curved arrow 84. Following a slice of this trajectory being taken, microscopic examination of the slice or block face by any number of methods can determine areas of the slice with good imaging characteristics. This location in turn encodes the optimal rake angle which can be applied to future slices.

In a second motion strategy, the specimen 26 may be moved cylindrically in the x-y axes. This slice motion can be used in a number of different scenarios. It can be used analogously to the above to instead explore a number of attack angles using a single slice. Again microscopic examination will be used to determine the location and corresponding optimal parameter of blade-yaw.

Both of these methods can be used with positive or negative curvature, as well as circles whose center is not aligned with the sample. Often, the radius of the circle that is traces is much larger than the sample, as only a small variation in rake angle (−10) is needed for any sample.

Oscillatory Motion Strategies.

The specimen 26 may be moved in an oscillating manner in many ways. Oscillatory motion trajectories are trajectories that can be added constructively to the other trajectories listed above. Independently, they do not represent a direction of travel, but when used in conjunction with other motions they can provide significant improvements in slice quality and subsequent imaging clarity.

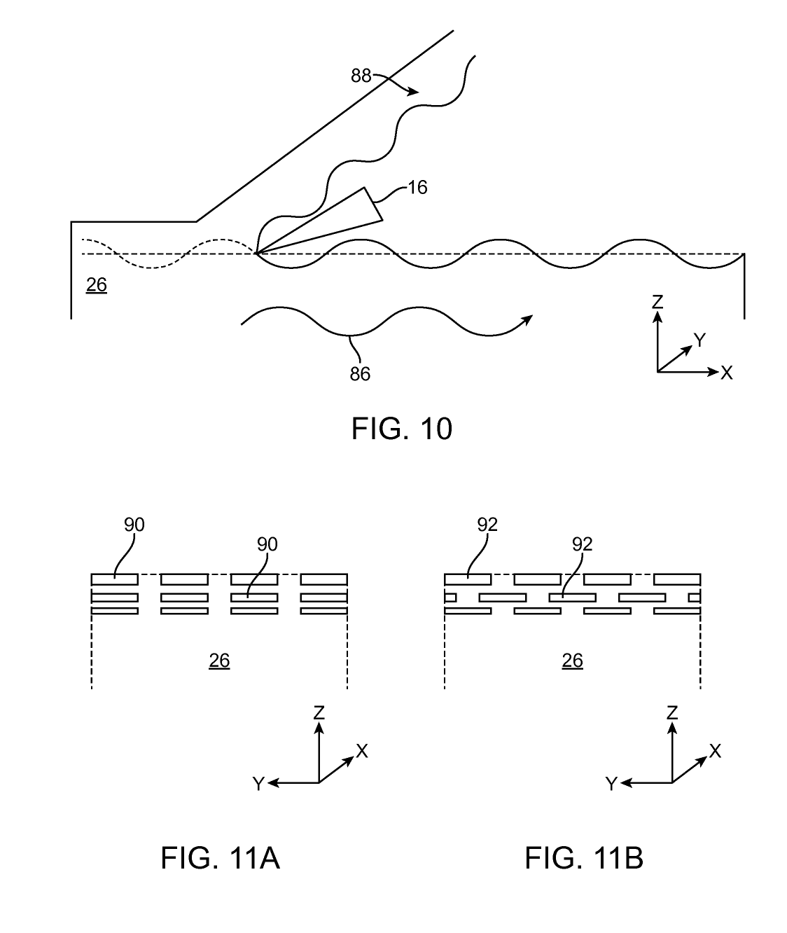

A useful example of such oscillating control strategies is the addition of a small high-frequency oscillation in the y-axis. This oscillation has been found to mimic the behavior of more complicated vibratome knife designs, may notably lower measured friction during the slicing motion in other axes, and can reduce chatter and some small stripe artifacts. Another useful example, shown in FIG. 10, includes a lower frequency oscillation in the z-axis with which multiple slice thickness can be tested over single slices by inspection strategies previously mentioned. As shown in FIG. 10, the specimen 26 may be moved toward the microtome 16 in the x-axis while oscillating the specimen 26 in the z-axis as indicated by oscillating arrow 86 to generate a slice or section 88 with multiple thicknesses. Oscillations may, for example, be at a frequency of 50 Hz to 20 kHz.

Composite Motion Strategies.

There are additionally a number of coordinated motions and motion paths in three dimensions and time which the three-dimensional precision stage can move the specimen 26. Such motion paths may be a composite from one or more of the above strategies. The following examples of motion paths have been found to be useful.

One, a trajectory with three connected linear segments in the following order: (i) a plunging (very low clearance angle) cut to enter the face of the block without curling, (ii) a long linear motion to take a coherent slice, and (iii) a lifting cut to break the slice free of the front of the microtome blade may be useful in many embodiments. The first linear segment may be cut by moving the specimen 26 against the microtome 16 in the x-axis a first distance and concurrently moving the specimen 26 against the microtome 16 in the z-axis a second distance greater than the first distance. The second linear segment may be cut by moving the specimen 26 against the microtome 16 in the x-axis without moving the specimen in the z-axis. The third linear segment may be cut by moving the specimen 26 against the microtome in an opposite manner of the way the first linear segment was generated. This movement trajectory may reduce the incidence of curling for a slice of the specimen 26.

Two, a series of sequential linear or cylindrical cuts (such as the linear or cylindrical cuts described above) may be taken to test materials and slicing properties as a function of rake angles may be useful in many embodiments.

Three, a series of sequential cuts set consistently in the y-axis to provide slices of known dimension from a large block face may be useful. Such cuts 90 are shown in the schematic of the specimen 26 of FIG. 11A. A first portion of a first layer of the specimen 26 may be cut in the x-axis. Once the first portion of the first layer is cut, the specimen 26 may be moved in the y-axis to cut a second portion of the first layer. This process may be repeated until the first layer is entirely cut and imaged. The same process may then be repeated for the second layer of the specimen 26 by moving the specimen 26 up in the z-axis. As shown in FIG. 11A, the individually cut portions of the specimen 26 may be aligned with one another in the z-axis.

Four, a series of sequential cuts as above, with variable offset in the y-axis per face to either minimize appearance of slicing artifacts from previous layers and/or to insure that slice edges to not overlap between slice layers. Such cuts 92 are shown in the schematic of the specimen 26 of FIG. 11B. A first portion of a first layer of the specimen 26 may be cut in the x-axis. Once the first portion of the first layer is cut, the specimen 26 may be moved in the y-axis to cut a second portion of the first layer. This process may be repeated until the first layer is entirely cut and imaged. The same process may then be repeated for the second layer of the specimen 26 by moving the specimen 26 up in the z-axis. As shown in FIG. 11B, the individually cut portions of the specimen 26 may be offset in adjacent layers in the z-axis.

Embodiments of the disclosure may further include methods for manipulating a specimen with the precision three-dimensional stage to generate any of the above described cuts, sections, or slices. The three-dimensional stage may be controlled by user-entered commands to generate the desired motion trajectory. A processor and machine readable medium embodying specific motion trajectory instructions for the precision stage may be provided to the imaging system 10 to implement the motion trajectory instructions. The processor and machine readable medium may also be configured to record the implemented motion trajectory, and the recorded motion trajectory may be inverted, by the processor for example, to correct coordinate data of a specimen slice image.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the systems and methods described herein may be employed in practicing the embodiments described herein. It is intended that the following claims define the scope of disclosure and that methods and structures within the scope of these claims and their equivalents be covered thereby.

What is claimed is:

1. A method of imaging an object, the method comprising:
moving the object with respect to a first axis against a cutting tool to cut a portion of the object;
moving the object with respect to a second axis against the cutting tool to cut the portion, wherein the second axis is orthogonal to the first axis; and
generating an image of the cut portion as the object is moved with respect to both the first and second axes, wherein the object is moved with respect to the first axis and second axis concurrently.

2. The method of claim 1, further comprising moving the object with respect to a third axis against the cutting tool to cut the portion, wherein the third axis is orthogonal to both the first axis and the second axis, and wherein the object is moved with respect to the first axis, the second axis, and the third axis concurrently.

3. The method of claim 2, wherein the third axis comprises a Z-axis orthogonal to a length of a cutting edge of the cutting tool and orthogonal to a width of a body of the cutting tool.

4. The method of claim 1, wherein the first axis comprises an X-axis orthogonal to a length of a cutting edge of the cutting tool and along a width of a body of the cutting tool.

5. The method of claim 1, wherein the second axis comprises a Y-axis along a length of a cutting edge of the cutting tool and orthogonal to a width of a body of the cutting tool or a Z-axis orthogonal to the length of a cutting edge of the cutting tool and orthogonal to the width of a body of the cutting tool.

6. The method of claim 1, wherein the cutting tool is stationary relative to the moved object.

7. The method of claim 1, further comprising:
directing optical energy out of the cutting tool and through the portion of the object; and
receiving the directed optical energy at an optical element while the portion is cut such that data relating to an image associated with the portion is communicated to the optical element.

8. The method of claim 7, wherein the optical element comprises a camera.

9. The method of claim 7, further comprising providing the optical energy at a proximal end of the cutting tool and internally-reflecting, by the cutting tool, the provided optical energy from the proximal end to a distal end of the cutting tool, wherein directing optical energy out of the cutting tool comprises directing the internally reflected optical energy out of the distal end.

10. The method of claim 1, wherein moving the object along the first axis comprises moving the object a first distance, and wherein moving the object along the second axis comprises moving the object a second distance different from the first distance.

11. The method of claim 10, wherein the second distance is less than the first distance.

12. The method of claim 1, further comprising changing an angle of a top surface of object against a bottom surface of the cutting tool as the object is moved along the first and second axes concurrently.

13. The method of claim 1, wherein moving the object along the second axis comprises oscillating the object along the second axis.

14. The method of claim 1, wherein the object is oscillated along the second axis such that the cut portion has a varying thickness

15. The method of claim 1, wherein the object is moved with respect to the first axis and second axis concurrently to generate a first steep cut in a first direction in the portion of the object, to generate a second flat cut in the portion of the object, and to generate a third steep cut in a second direction opposite the first direction in the portion of the object.

16. A system comprising a processor and tangible medium embodying instructions for implementing the method of claim 1.
